(19) United States
(12) Patent Application Publication
(10) Pub. No.: US 2008/0255694 A1
(43) Pub. Date: Oct. 16, 2008

(54) Evaluating supplier capacity

(76) Inventors: Cheryl A. Sprague, East Peoria, IL (US); Karen S. Falkner, Avon, IN (US); Michael L. Rebatzke, Mapleton, IL (US); Erika M. Benton, Pekin, IL (US); Elmer L. Kiesewetter, East Peoria, IL (US); Robert A. Manasco, Peoria, IL (US); Cristina M. Ham, Morton, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/785,182

(22) Filed: Apr. 16, 2007

(51) Int. Cl. G06F 19/00

(52) U.S. Cl. 700/106

(57) ABSTRACT

Methods and systems evaluate a capacity of a supplier to meet a capacity requirement for a part for a time period. In one implementation, a method is provided. According to the method, a forecast is transmitted to a supplier that indicates the capacity requirement. The method receives an actual capacity of the supplier to produce the part for the time period and determines whether the actual capacity of the supplier meets the capacity requirement. When the actual capacity of the supplier does not meet the capacity requirement, the method receives, from the supplier, a plan specifying how the supplier plans to meet the capacity requirement.

### TECHNICAL FIELD

The present disclosure relates generally to evaluating supplier capacity, and more particularly, to a system and method for improved communication between a customer and a supplier.

### BACKGROUND

Parts that are used in the manufacture of a product are acquired from suppliers. In that respect, a manufacturer is considered a customer of the suppliers. For example, the customer might place an order a month in advance with a supplier for a quantity of a part. Alternatively, the customer might place a standing order for a quantity of the part that is needed each month. Suppliers are typically able to meet the customer's demand when the quantity does not increase significantly. However, when the customer increases the quantity by a substantial amount, the supplier might not have sufficient capacity to fill the customer's orders.

The inability of suppliers to meet demand is a significant problem for a customer in several respects. Most notably, when a supplier cannot meet the customer's demand, the customer incurs increased costs because the customer may need to order the part from another supplier at an increased cost. Furthermore, if the supplier does not inform the customer sufficiently in advance that it cannot fill the order, the customer may need to obtain the part on an expedited basis from another supplier. Expedited orders can incur a significant cost premium. Moreover, the unpredictability and unreliability of a supplier can have more significant consequences when a customer cannot deliver products to its customers due to part shortfalls.

Other customers may face similar problems. For example, retailers might require a certain number of items, which the retailer expects to sell in a particular time period. When a supplier is unable to meet the retailer's orders, the retailer may face similar problems to those discussed above.

U.S. Pat. No. 6,684,119 B2 (the '119 patent) to Burnard et al. discloses a method of providing dynamic production material replenishment information via the Internet. According to the '119 patent, the method tracks real-time usage of a material used for a product and provides a user with Internet access to the usage information. However, the system of the '119 patent does not facilitate an interaction between the supplier and the customer in order for the supplier to indicate how the supplier intends to increase capacity to meet the customer's requirements.

The disclosed embodiments are directed to overcoming one or more of the problems set forth above.

### SUMMARY OF THE INVENTION

In one aspect, the present disclosure is directed to a method for evaluating a capacity of a supplier to meet a capacity requirement for a part for a time period. According to the method, the method may transmit a forecast to a supplier that indicates the capacity requirement. The method may receive an actual capacity of the supplier to produce the part for the time period and determine whether the actual capacity of the supplier meets the capacity requirement. When the actual capacity of the supplier does not meet the capacity requirement, the method may receive, from the supplier, a plan specifying how the supplier plans to meet the capacity requirement.

In another aspect, the present disclosure is directed to a system for evaluating a capacity of a supplier to meet a capacity requirement for each subdivision of a time period. The system may comprise a server. The server may comprise a database that stores a forecast indicating the capacity requirements. The server may receive actual capacities of the supplier to produce a part for each of the subdivisions and determine whether the actual capacities of the supplier for each of the subdivisions meets a corresponding one or more of the capacity requirements for each of the subdivisions. When one or more of the actual capacities of the supplier does not meet the corresponding one or more of the capacity requirements, the server may receive, from the supplier, a plan specifying how the supplier plans to meet the corresponding one or more of the capacity requirements.

In yet another aspect, the present disclosure is directed to a method for evaluating a capacity of a supplier to meet capacity requirements for a time period having a plurality of subdivisions. The method may include transmitting, to the supplier, a forecast indicating the capacity requirements for each of the subdivisions; receiving actual capacities of the supplier to produce an item for each of the subdivisions; and determining whether one or more of the actual capacities of the supplier meets a corresponding one or more of the capacity requirements.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an example of a system that enables a customer to evaluate a supplier's capacity to meet a capacity requirement of the customer;

FIGS. 2A-2G are examples of user interfaces;

FIG. 3 is an example of a software architecture for implementing a tool that enables a customer to evaluate a supplier's capability to meet a capacity requirement of the customer;

FIG. 4 is a flow diagram of an example of a method for forecasting a customer's demand; and

FIG. 5 is a flow diagram of an example of a method that enables a customer to evaluate a supplier's capability to meet a capacity requirement of the customer.

### DETAILED DESCRIPTION

Reference will now be made in detail to the following exemplary embodiments, which are illustrated in the accompanying drawings. Wherever possible, the same reference numbers will be used throughout the drawings to refer to the same or like parts.

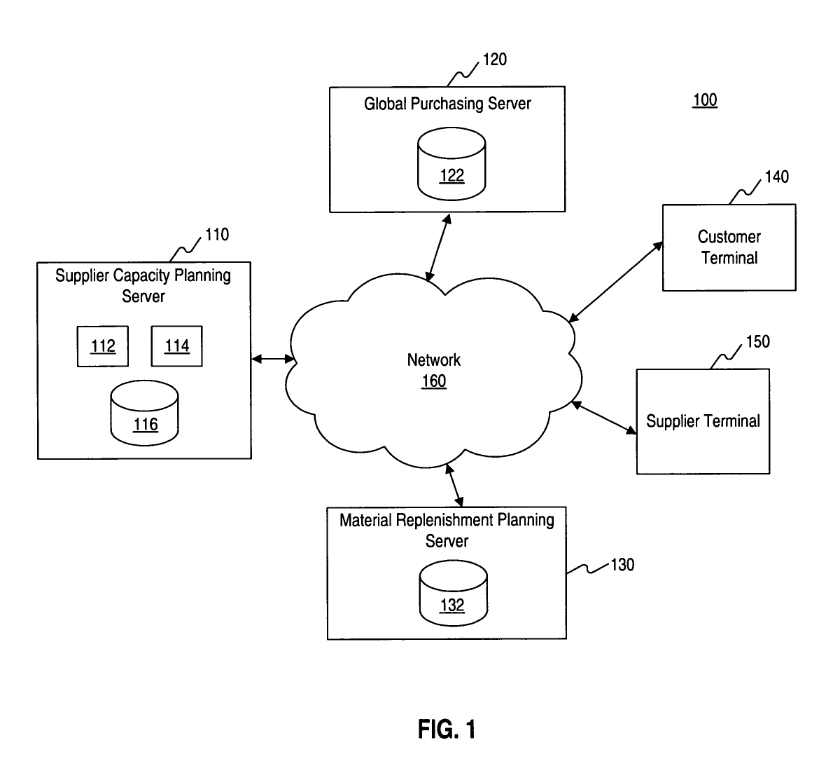

FIG. 1 is an example of a system 100 that enables a customer to evaluate a supplier's capability to meet a capacity requirement of the customer. In particular, system 100 may receive capacity information, forecast capacity requirements for the customer, and provide one or more suppliers with access to the customer's capacity requirements. Furthermore, system 100 may facilitate an interaction between the supplier and the customer. The interaction may enable the supplier to submit a plan that indicates how the supplier intends to increase its capacity to meet the customer's requirements. Accordingly, the customer, having the benefit of the supplier's plan, may better foresee part shortfalls and determine whether to place orders with additional or alternative suppliers to ensure sufficient capacity.

As shown in system 100, supplier capacity planning server 110, global purchasing server 120, material replenishment planning server 130, and terminals 140 and 150 are connected to a network 160. One of skill in the art will appreciate that although a specific numbers of servers and two terminals are depicted in FIG. 1, any number of these entities may be provided. Furthermore, one of ordinary skill in the art will recognize that functions provided by one or more entities of system 100 may be combined. In particular, the functionality of any one or more entities of system 100 may be implemented by any appropriate computing environment.

Network 160 provides communications between the various entities in system 100, such as supplier capacity planning server 110, global purchasing server 120, material replenishment planning server 130, and terminals 140 and 150. In addition, supplier capacity planning server 110, global purchasing server 120, material replenishment planning server 130, and terminals 140 and 150 may access legacy systems (not shown) via network 160, or may directly access legacy systems, databases, or other network applications. Network 160 may be a shared, public, or private network, may encompass a wide area or local area, and may be implemented through any suitable combination of wired and/or wireless communication networks. Furthermore, network 160 may comprise a local area network (LAN), a wide area network (WAN), an intranet, or the Internet.

Supplier capacity planning server 110 may comprise a computer (e.g., a personal computer, network computer, server, or mainframe computer) having a processor 112 that may be selectively activated or reconfigured by a computer program. Supplier capacity planning server 110 may also be implemented in a distributed network. For example, supplier capacity planning server 110 may communicate via network 160 with global purchasing server 120 and/or material replenishment planning server 130. Alternatively, supplier capacity planning server 110 may be specially constructed for carrying-out methods consistent with disclosed embodiments.

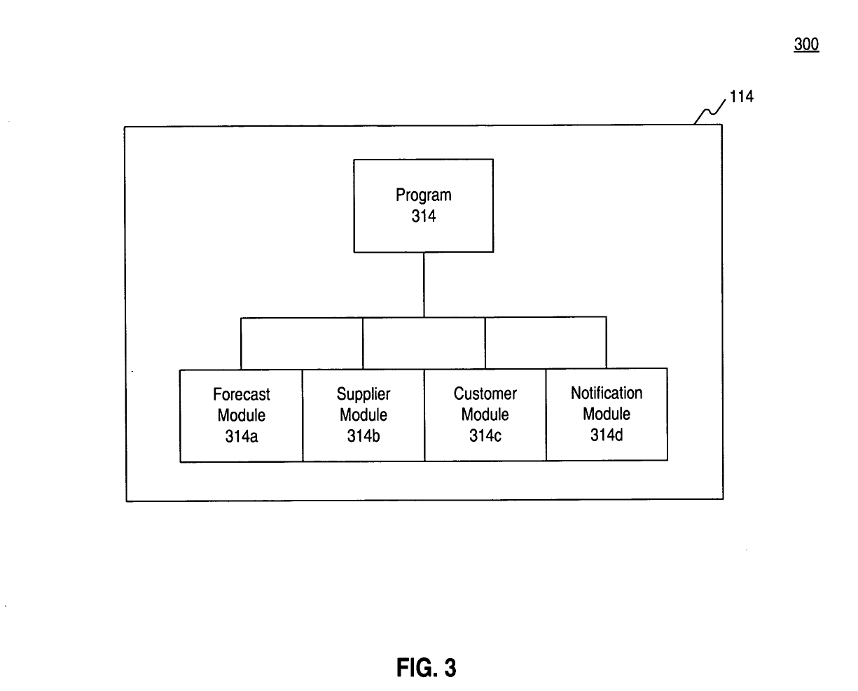

Supplier capacity planning server 110 may include a database 116 for storing forecasts for a time period (e.g., a weekly, monthly, or a multi-year forecast). Supplier capacity planning server 110 may further include a memory 114 for storing program modules that, when executed by processor 112, perform one or more processes for implementing a tool for evaluating a supplier's ability to meet a capacity requirement of a customer. Memory 114 may be one or more memory devices that store data as well as software. Memory 114 may also comprise one or more of RAM, ROM, magnetic storage, or optical storage, for example. The tool may be stored as one or more program modules in memory 114 of supplier capacity planning server 110. Program modules are discussed below in further detail with reference to FIG. 3. Furthermore, since disclosed embodiments may be implemented using an HTTPS (hypertext transfer protocol secure) environment, data transfer over a network, such as the Internet, may be done in a secure fashion.

In operation, the tool may allow suppliers to access and/or export forecast information for one or more parts or items ordered by the customer. The tool may provide the forecast information by part number, for example. Furthermore, the tool may allow suppliers to submit their actual current capacity for producing a part as well as their projected capacities for producing the part for a time period (e.g., projected capacities for the next five years). In the event that a supplier cannot meet projected capacity requirements, the tool may allow the supplier to specify a plan outlining how the supplier intends to accomplish a planned capacity increase. The plan may also specify the means in which the supplier plans to accomplish the planned capacity increase (e.g., hiring more workers, acquiring more equipment, or increasing factory floor space). For example, after reviewing an initial plan submitted by a supplier, the customer may require additional information specifying how the supplier plans to meet projected capacities for a time period. Accordingly, if the customer has questions or concerns regarding the plan, the tool may allow the customer to request further information from the supplier substantiating the plan.

Global purchasing server 120 may comprise a computer (e.g., a personal computer, network computer, server, or mainframe computer) having a processor (not shown) that may be selectively activated or reconfigured by a computer program. Global purchasing server 120 may include a database 122 storing information identifying parts that are obtained by a customer from one or more suppliers. For example, information identifying the parts may be stored in records according to part number and/or part name. Furthermore, global purchasing server 120 may communicate via network 160 with supplier capacity planning server 110 and/or material replenishment planning server 130.

Material replenishment planning server 130 may comprise a computer (e.g., a personal computer, network computer, server, or mainframe computer) having a processor (not shown) that may be selectively activated or reconfigured by a computer program. Material replenishment planning server 130 may include a database 132 storing demand information for parts that are used by a customer. Database 132 may store demand data for a particular time period (e.g., twelve months of demand data) for each of the parts. For example, database 132 may store an annual demand for one or more parts. The annual demand may represent historical data that reflects a total annual demand for the part across an enterprise for the time period or may be expressed as an annual demand on a per facility basis for the time period. Accordingly, the demand data stored by database 132 represents historical data of actual demand, which is suitable for use in projecting future demand, as discussed below in further detail. Furthermore, material replenishment planning server 130 may communicate via network 160 with supplier capacity planning server 110 and/or global purchasing server 120.

Terminals 140-150 may be any type of device for communicating with supplier capacity planning server 110, global purchasing server 120, and/or material replenishment planning server 130 over network 160. For example, terminals 140-150 may be personal computers, handheld devices, or any other appropriate computing platform or device capable of exchanging data with network 160. Terminals 140-150 may each include a processor (not shown) and a memory (not shown). Furthermore, terminals 140-150 may execute program modules that provide one or more graphical user interfaces (GUIs) for interacting with network resources and/or accessing supplier capacity planning server 110.

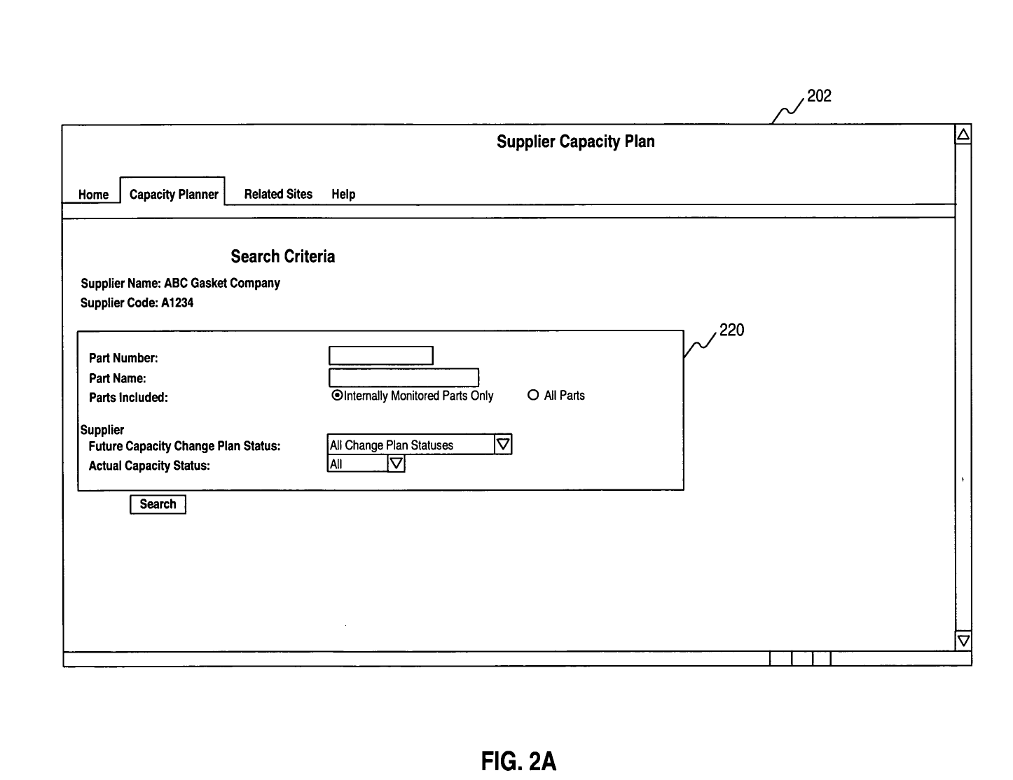

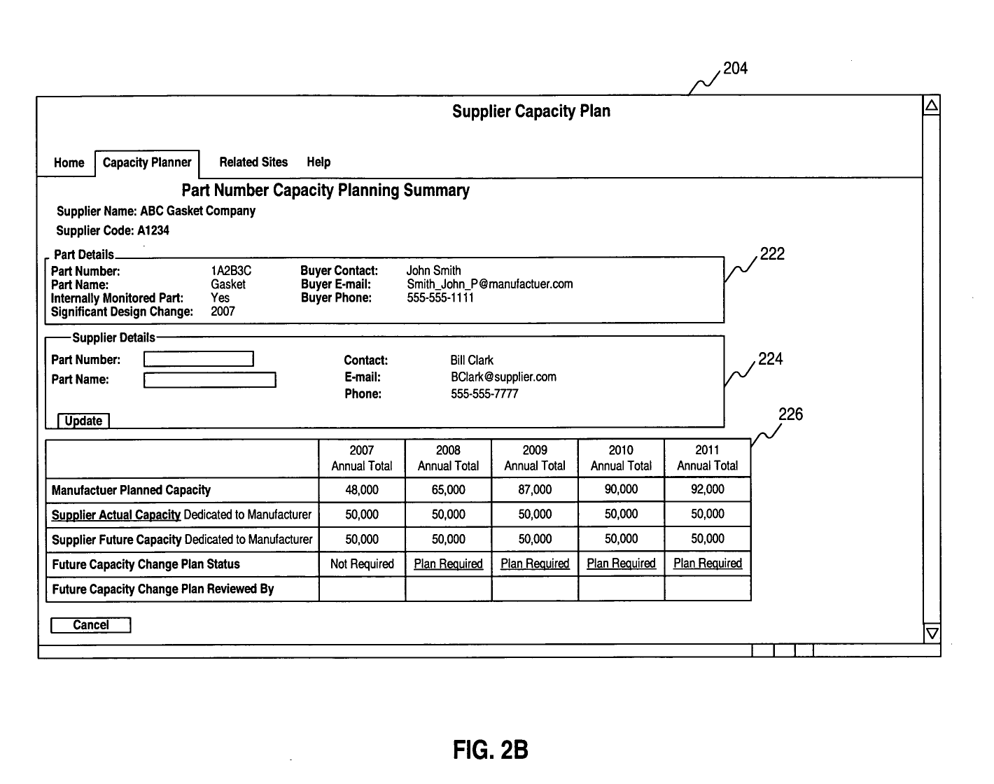

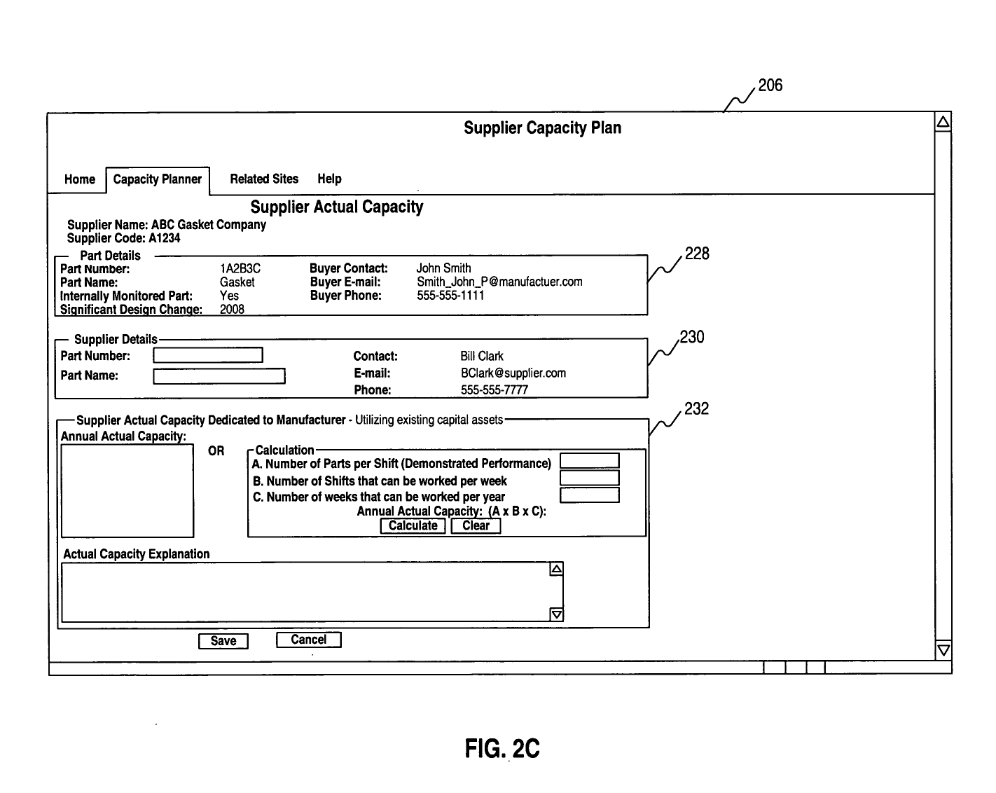

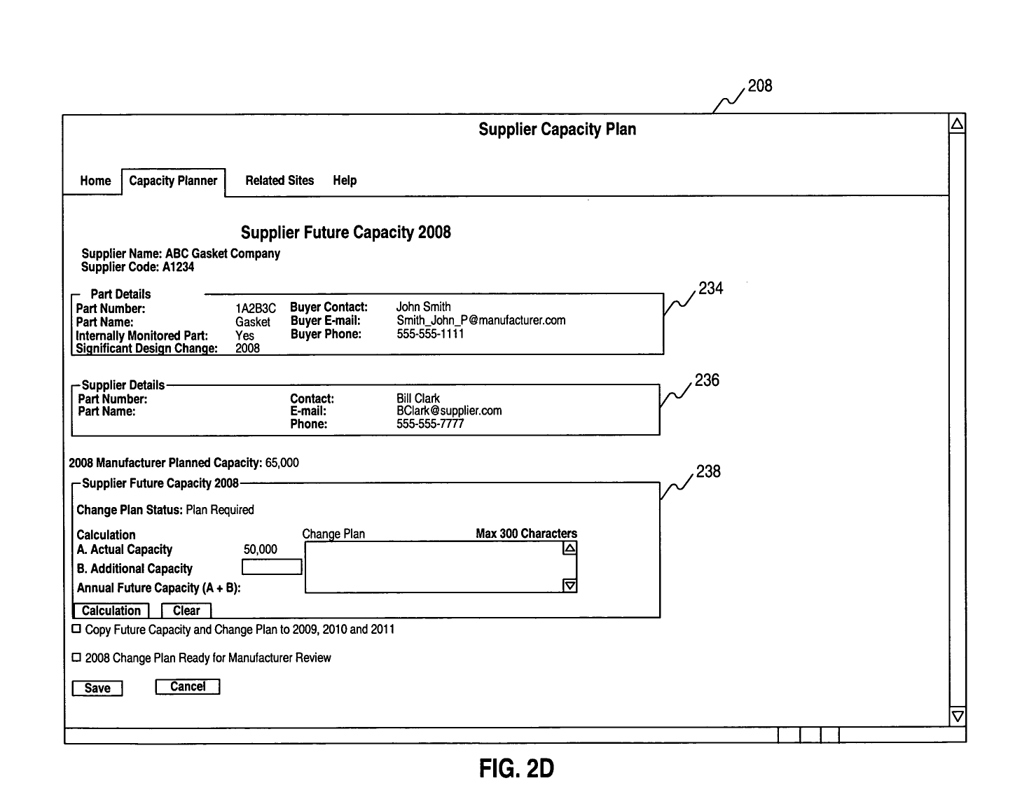

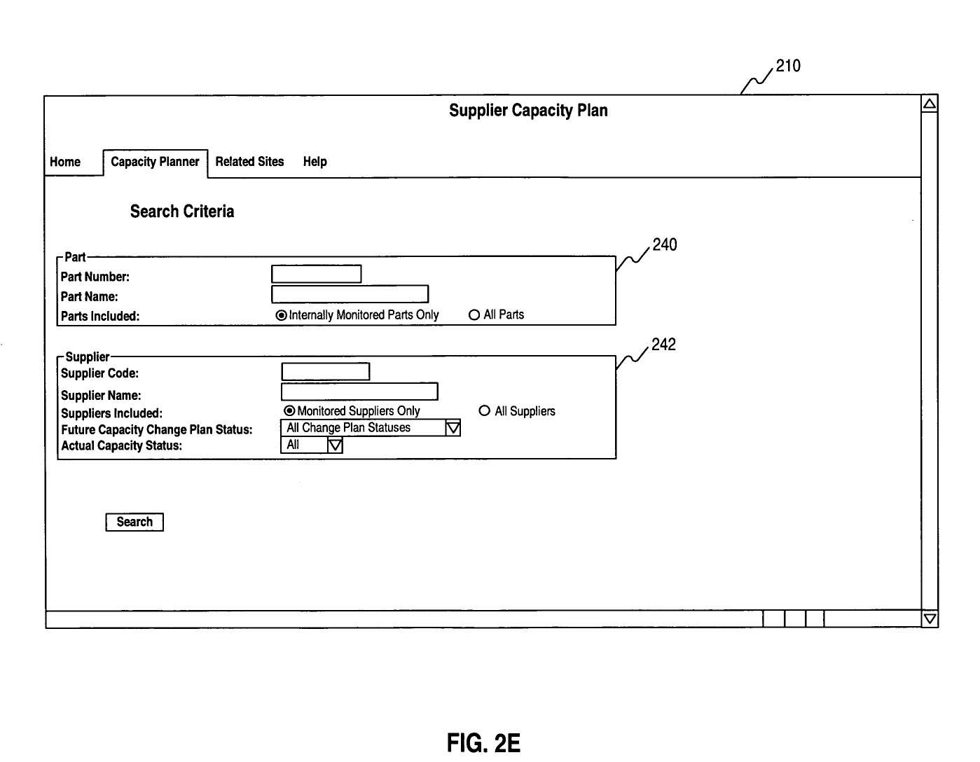

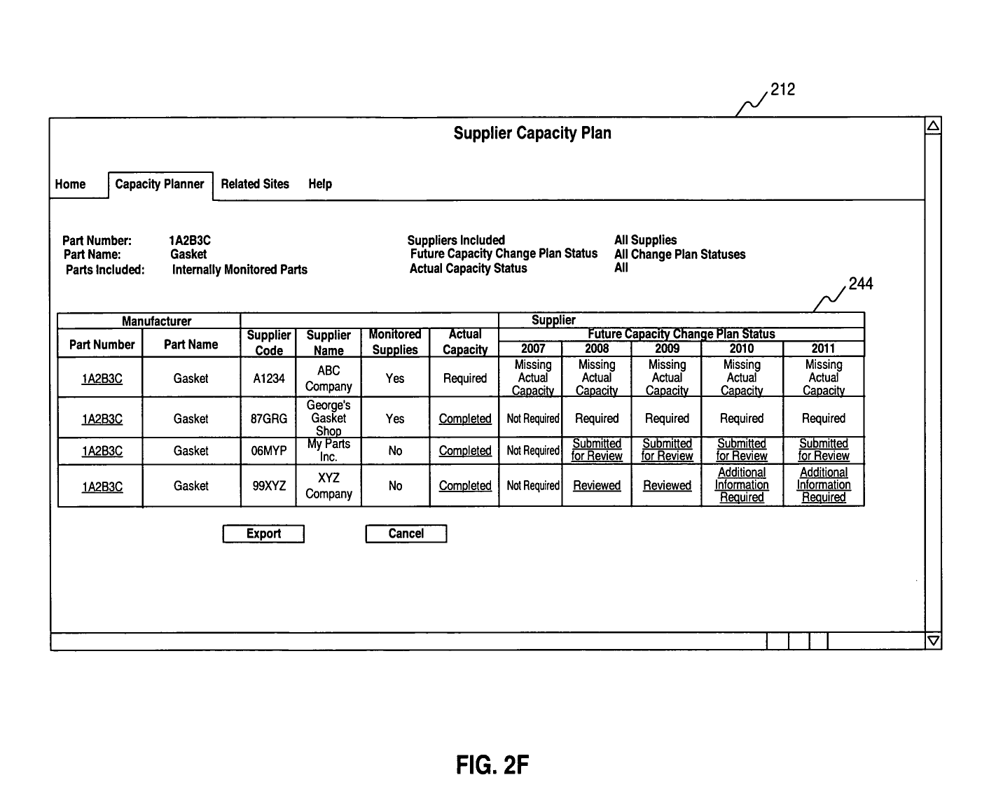

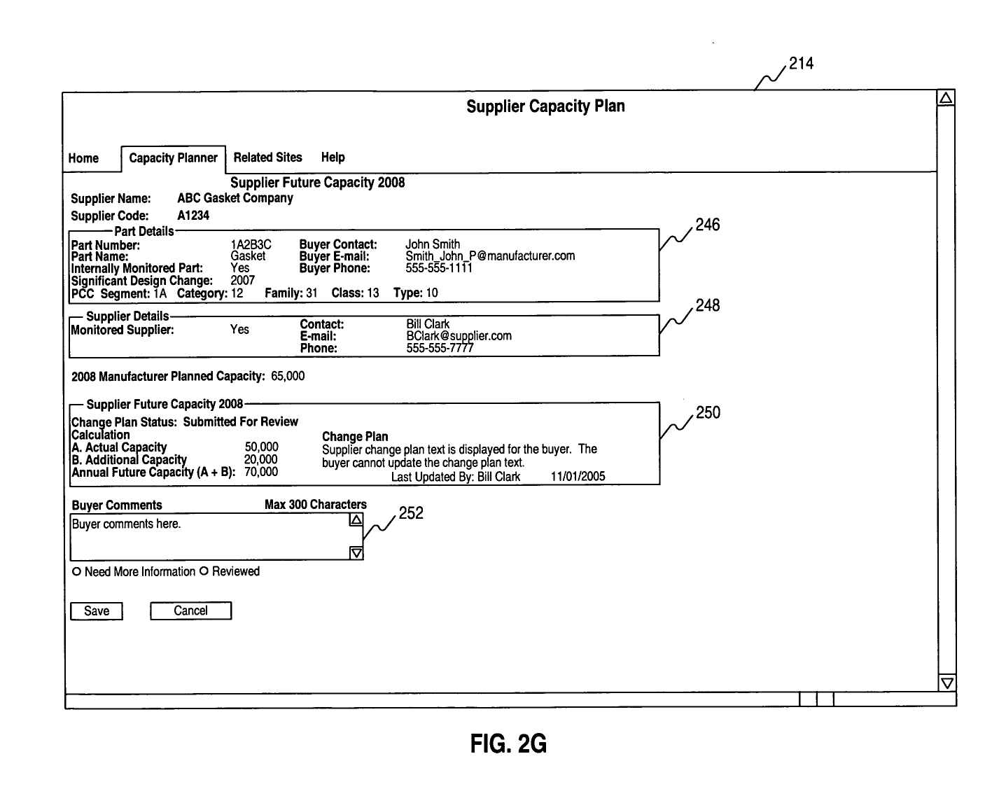

Users of terminals 140-150 may include employees of the customer and/or employees of one or more suppliers. For purposes of illustration, terminal 140 is labeled as a “customer terminal” and terminal 150 is labeled as a “supplier terminal.” Users of terminals 140-150 may access data over network 160 through a web browser or software application running on any one of terminals 140-150. For example, a web portal may include options for allowing a user, such as a customer or supplier, to log onto a secure site provided by supplier capacity planning server 110 by supplying credentials, such as a username and a password. Once logged onto the site, the web portal may display a series of screens prompting the user to make various selections. The selections that are available to a user may differ based on the user's status. For example, a supplier may be able to access and/or export forecast information for one or more parts that are ordered by the customer from the supplier. The supplier may also be requested or required to submit a plan indicating how the supplier plans to meet projected capacity requirements. On the other hand, the customer may access the site to view information submitted by suppliers and may request or require further information from the supplier. Examples of user interfaces are discussed below in further detail in connection with FIGS. 2A-G.

FIGS. 2A-2G are examples of user interfaces, which may be provided by the tool discussed above. For example, users of terminals 140-150 may log onto a secure site provided by supplier capacity planning server 110. After verification of the user's credentials (e.g., username and password), the user may navigate to one or more of the user interfaces shown in FIGS. 2A-2G. Although the user interfaces shown in FIGS. 2A-2G illustrate various screens for submitting and accessing data, one of ordinary skill in the art will appreciate that the user interfaces are examples and alternative and/or additional user interfaces may be provided.

FIG. 2A is an example of a user interface 202 for a supplier to enter search criteria. The supplier may enter the search criteria in portion 220 of user interface 202. As shown in user interface 202, a supplier is identified by name (i.e., ABC Gasket Company) after having logged into a secure site. The supplier may be further identified by a supplier code (i.e., A1234). As shown, the supplier may search for a part by part number or name in portion 220. Furthermore, the supplier may specify in portion 220 whether to search for parts that are “internally monitored” by the customer or “all parts.”

FIG. 2B is an example of a user interface 204 for a supplier to review capacity plan information. User interface 204 provides a part number capacity planning summary. As shown in a first portion 222 of user interface 204, part details (e.g., part number, part name, internally monitored part status, and an indication of a date when a significant design change will be required by the customer) are indicated, along with details describing the buyer. The buyer may refer to an employee of the customer with the responsibility for placing orders for a particular part. As shown in a second portion 224 of user interface 204, a supplier may provide their part number and/or part name and update their contact information.

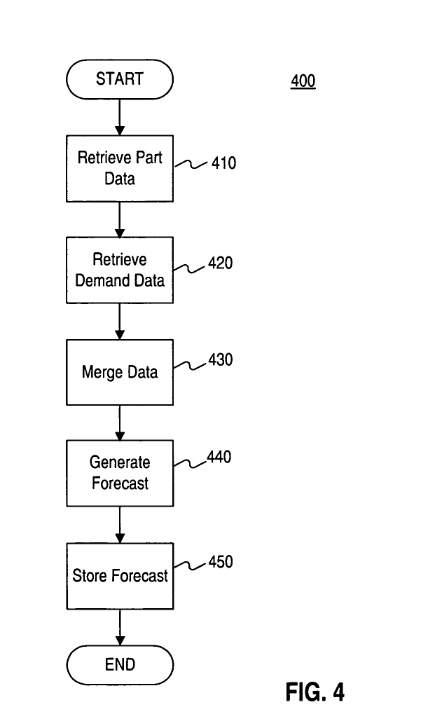

As shown in a third portion 226 of user interface 204 of FIG. 2B, the supplier may review a multi-year forecast. In this example, a five year forecast is shown. The five year forecast outlines the customer's planned capacity from 2007-2011 on an annual basis. In this example, the supplier has previously submitted the supplier's actual capacities for each year that is dedicated to the customer. The supplier's actual capacity may automatically be listed as the supplier's projected future capacities for each year until a change is made and saved. The projected future capacities may be determined, for example, as discussed below in further detail with reference to FIG. 4. Furthermore, since there is a shortfall between the supplier's actual capacity and future capacity for years 2008-2011, a hyperlink is shown to a user interface in which the supplier is requested or required to provide a plan for meeting the future capacity needs of the customer.

FIG. 2C is an example of a user interface 206 for a supplier to provide actual capacity data. A first portion 228 of user interface 206 identifies the supplier and the part, and a second portion 230 provides supplier details. In a third portion 232, the supplier may enter actual capacity information in one of two ways (i.e., either a total in the text box on the left hand side or numbers for a calculation on the right hand side). Third portion 232 further provides an opportunity for the supplier to submit a narrative describing how the actual capacity was determined. Furthermore, the supplier may save or cancel submission of the data.

FIG. 2D is an example of a user interface 208 for a supplier to provide future capacity data. A first portion 234 of user interface 208 identifies the supplier and the part, and a second portion 236 provides supplier details. In a third portion 238 of user interface 208, the supplier may enter future capacity information for a particular year (e.g., 2008). In this example, since the supplier's actual capacity (e.g., 50,000 units) does not meet the customer's planned capacity (e.g., 65,000 units), the supplier is required to submit a plan for changing capacity. The supplier is provided with a checkbox option below third portion 238 in which the supplier may copy the future capacity and change plan to other years (e.g., 2009, 2010, and 2011) or the supplier may elect to enter separate data for each year. The supplier is further provided with another checkbox option for transmitting a notification to the customer that the plan is ready for review. For example, when this option is selected, an alert message may be sent to a buyer representing the customer (e.g., to the buyer's e-mail address).

FIG. 2E is an example of a user interface 210 for a customer, such as a supplier, to enter search criteria. As shown, the customer may search for a part by part number or name using portion 240 of user interface 210. Furthermore, the customer may specify whether to search for parts that are “internally monitored” by the customer or “all parts.” The customer may also search by supplier code or supplier name in order to retrieved part data for a specific supplier using portion 242 of user interface 210.

FIG. 2F is an example of a user interface 212 for a customer to review information submitted by a supplier. FIG. 2F illustrates an example wherein the customer has retrieved the data for a particular part (i.e., part number 1A2B3C) and that data is displayed in table 244. Accordingly, the customer may review a summary of data for suppliers that provide the part by referring to table 244. Furthermore, using hypertext links that are included in fields of table 244, the customer may view specific data for a particular supplier, such as the supplier's plan, if it has been submitted.

FIG. 2G is an example of a user interface 214 for a customer to review a change plan of a supplier. As shown, part details are displayed in a first portion 246 and supplier details are displayed in a second portion 248. The supplier's future capacity is indicated for a specific year (i.e., 2008) in a third portion 250. Furthermore, FIG. 2G illustrates the supplier's change plan in third portion 250. The buyer representing the customer may send comments to the supplier using a fourth portion 252. For example, the buyer can indicate that the plan has been reviewed (i.e., deemed sufficient for the buyer's needs) or may request more information. When a buyer provides comments, an alert message may be sent to the contact person of the supplier (e.g., to the supplier's e-mail address).

FIG. 3 is an example of a software architecture for implementing a tool that enables a customer to evaluate a supplier's capability to meet a capacity requirement of the customer. The software architecture may be stored in memory 114 of supplier capacity planning server 110, as shown in FIG. 1, for example. In other embodiments, the software architecture may be stored in, for example, any one of terminals 140-150.

In one embodiment, memory 114 may store instructions of program 314, which when executed, perform one or more data processes for executing the tool. To do so, program 314 may include instructions in the form of one or more program modules 314a-314d. Program modules 314a-314d may be written using any known programming language, such as C++, XML, etc., and may include a forecast module 314a, a supplier module 314b, a customer module 314c, and a notification module 314d.

Forecast module 314a may retrieve data from global purchasing server 120. As discussed above, database 122 of global purchasing server 120 may store information identifying parts that a customer obtains from one or more external suppliers. Database 122 may store information identifying the parts according to part number. Forecast module 314a may retrieve data from database 116 for one or more parts and may, for example, forecast demand for one of the parts or a plurality of parts. Forecast module 314a may exclude a part from a forecast if data stored in database 122 indicates that the part has not been ordered for a significant time period (e.g., the customer has not ordered the part for over six months).

Forecast module 314a may also retrieve data from material replenishment planning server 130. As discussed above, database 132 of material replenishment planning server 130 may store demand information for parts. Database 132 may store demand information on a per facility basis that represents demand for a part for a time period (e.g., 12 months of historical demand data). Forecast module 314a may merge into one file data representing demand data for one or more parts across all facilities for the time period (e.g., data representing 12 months of historical demand data). Forecast module 314a may process the merged data file in order to generate a forecast of how many parts are needed for each year of a multi-year time period. The forecast may be computed using an appropriate forecasting model. For example, based on the demand data, forecast module 314a may extrapolate a future demand using the demand data as a basis for the forecast. Once computed, forecast module 314a may store the forecast in, for example, database 116.

Supplier module 314b may authenticate a supplier's credentials (e.g., username and password) that a supplier may submit when accessing a website provided by server 110. Furthermore, supplier module 314b may provide functionality for searching for parts by part number and/or part name and may receive information from the supplier, such as discussed above in connection with FIGS. 2A-2G. For example, supplier module 314b may allow suppliers to submit their actual current capacity as well as their projected capacities for a time period (e.g., projected capacities for the next five years). In the event that a supplier cannot meet projected capacity requirements, supplier module 314b may allow the supplier to indicate a planned capacity increase and the means in which the supplier plans to accomplish the planned capacity increase.

Customer module 314c may authenticate a customer's credentials (e.g., username and password) that a customer may submit when accessing a website provided by server 110. Furthermore, customer module 314c may provide functionality for searching for suppliers by, for example, supplier name or supplier code, as discussed above in connection with FIGS. 2A-2G. For example, customer module 314c may display data for a supplier, including a supplier's planned future capacity. Upon review of the data, the customer may require additional information specifying how the supplier plans to meet projected capacities for the time period. If the customer has questions or concerns regarding the plan, customer module 314c may allow the customer to request further information from the supplier.

Notification module 314d may send alerts to customers and/or suppliers. For example, notification module 314d may generate and format an appropriate message (such as an e-mail, voice mail, text message, etc.) and transmit that message to another system or one of terminals 140-150 for a customer and/or supplier. For example, the supplier may be requested to submit a plan indicating how the supplier plans to meet projected capacity requirements. Once that plan has been submitted, notification module 314d may transmit an appropriate message to the customer supervising orders that are placed with that supplier (e.g., sending an e-mail message to the buyer's e-mail address). Furthermore, the customer may transmit an appropriate message to a supplier in order to request further information from the supplier, such as information substantiating the supplier's plan to increase capacity in the future.

Although program modules 314a-314d have been described above as being separate modules, one of ordinary skill in the art will recognize that functionalities provided by one or more modules may be combined.

Referring now to FIG. 4, a flow diagram 400 is provided of an example of a method for forecasting a customer's demand. For example, the method may implement processes according to one or more of program modules 314a-314d.

At the start of the process, in step 410, forecast module 314a may retrieve data from global purchasing server 120. As discussed above, database 122 of global purchasing server 120 may store information identifying parts that a customer obtains from one or more suppliers. For example, database 122 may store information identifying parts according to part number and/or part name. In this step, forecast module 314a may retrieve data from database 116 for one or more parts. For example, forecast module 314a may forecast demand for one part or may execute batch processing to forecast demand for a plurality of parts. During this step, forecast module 314a may exclude a part from a forecast if data stored in database 122 indicates that the part has not been ordered for a significant time period (e.g., the part has not been ordered for over six months, the part has not been ordered for over twelve months, etc.). Furthermore, data may be retrieved based on part number. For some parts, the part number may include an engineering change number (ECN) if a part has been modified in some fashion that is specific to the customer. The process proceeds to step 420.

Next, in step 420, forecast module 314a may retrieve data from material replenishment planning server 130. As discussed above, database 132 of material replenishment planning server 130 may store historical demand information for parts. Database 132 may store demand information across an enterprise or on a per facility basis. For example, a customer may have five facilities that use a particular part. Accordingly, database 132 may store demand information for each facility that represents demand for that part for a time period (e.g., 12 months of demand data). The process proceeds to step 430.

In step 430, forecast module 314a may merge data that was retrieved in step 420 into one file representing demand information for one or more parts across all facilities for the time period (e.g., data representing 12 months of demand data). The process proceeds to step 440.

In step 440, forecast module 314a may process the merged data file in order to generate a forecast of how many parts are needed for each year of a time period, such as a multi-year time period. For example, forecast module 314a may forecast demand for a five year period, including demand data for each year of the five year period. The process proceeds to step 450 in which the forecast is stored in, for example, database 116. The process then ends.

As one of ordinary skill in the art will appreciate, one or more of steps 410-450 may be optional and may be omitted from implementations in certain embodiments.

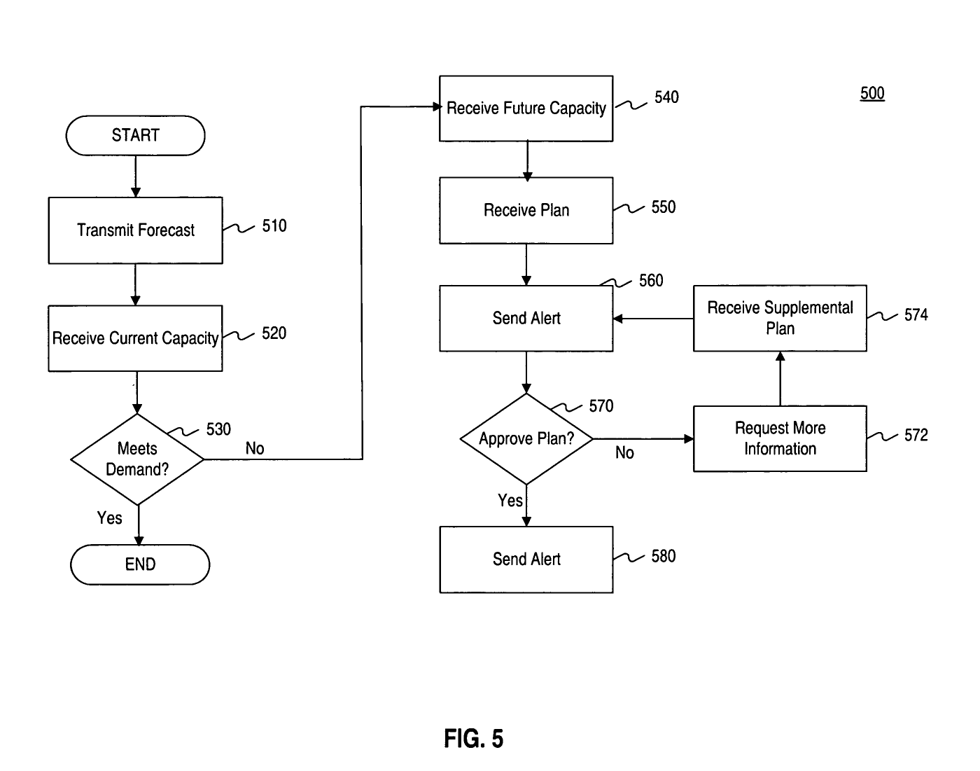

FIG. 5 is a flow diagram 500 of an example of a method that enables a customer to evaluate a supplier's capability to meet a capacity requirement of the customer. For example, the method may implement processes according to one or more of program modules 314a-314d. Furthermore, when collecting and/or transmitting data, supplier capacity planning server 110 may generate one or more of the user interfaces shown in FIGS. 2A-2G.

Parts that subject to the following process may be stored in supplier capacity planning server 110 with a monitored parts indicator. That is, for a customer having a large number of parts, the monitored parts indicator may specify certain parts that the customer wishes to have monitored for a particular reason (e.g., due to the importance of the part). Furthermore, suppliers subject to the following process may be identified in supplier capacity planning server 110 by a monitored supplier indicator. In a similar fashion, a monitored supplier indicator may specify whether a supplier is or is not a supplier that a customer wishes to have monitored for a particular reason (e.g., due to the number of parts or importance of the parts provided by the supplier).

At the start of the process, in step 510, supplier capacity planning server 110 may transmit forecast data for one or more parts to a supplier. The forecast data may be retrieved from database 116 of supplier capacity planning server 110, as discussed above in connection with FIG. 4, for example. The forecast data may include planned capacity requirements for a time period or for a plurality of subdivisions of a time period. For example, the forecast data may include required capacities on an annual basis for a part during a multi-year forecast period (e.g., a five year forecast). As shown in FIG. 2B, for example, a customer that is a manufacturer has indicated planned capacity requirements for the years 2007 through 2011 on an annual basis. The process proceeds to step 520.

In step 520, supplier capacity planning server 110 may receive information from the supplier indicating the supplier's current capacity for the time period or for each of the plurality of subdivisions of the time period. For example, as shown in FIG. 2B, the supplier has indicated the supplier's current capacity for each of years 2007 through 2011 on an annual basis. The process proceeds to step 530.

In step 530, supplier capacity planning server 110 may determine whether there is a gap between the supplier's actual capacity or capacities and the future capacity or capacities required by the customer. If there is not a gap in step 530, then the process ends. However, if there is a gap, then the process proceeds to step 540. For example, as shown in FIG. 2B, the supplier is able to meet the capacity requirement of the customer for 2007. However, there is a gap between the projected actual capacities of the supplier for years 2008 through 2011. Accordingly, for this example, the supplier is required to provide a plan for years 2008 through 2011.

In step 540, supplier capacity planning server 110 may receive information from the supplier indicating a future capacity that the supplier expects to be able to provide the customer on for the time period or for each of the plurality of subdivisions of the time period. For example, as shown in FIG. 2B, the supplier has indicated the supplier's future capacities for each of years 2007-2011 on an annual basis. The process proceeds to step 550.

In step 550, supplier capacity planning server 110 may receive a plan from the supplier that describes how the supplier expects to increase capacity to meet the customer's requirements. For example, the plan may indicate that the supplier intends to hire more workers, acquire more equipment, or increase factory floor space. As shown in FIG. 2D, the supplier may provide a description of the plan. The process proceeds to step 560.

In step 560, supplier capacity planning server 110 may transmit an alert to an employee of the customer that is responsible for overseeing orders placed with the supplier. For example, the alert may indicate that the supplier has submitted the plan. The process proceeds to step 570.

In step 570, an employee of the customer may review the plan and determines whether the plan is sufficient. If the plan is sufficient, the process proceeds to step 580.

In step 580, supplier capacity planning server 110 may transmit an alert message to the supplier indicating that the plan is sufficient and the process ends. If the plan is not sufficient, or the employee has further questions, the process proceeds to step 572.

In step 572, supplier capacity planning server 110 may transmit a response to the supplier indicating that the plan is not sufficient and/or requesting further information and/or a telephone call with the supplier to discuss the issue further.

In step 574, supplier capacity planning server 110 may receive a supplemental plan from the supplier. The supplemental plan may address questions and/or concerns that were raised by the customer in step 572. The process returns to step 560, where an alert message of the updated plan is sent to the customer.

As one of ordinary skill in the art will appreciate, on or more of steps 510-580 may be optional and may be omitted from implementations in certain embodiments. Furthermore, one or more of steps 510-580 may be repeated in order to process data for a multi-year time period (e.g., for a five year time period).

### INDUSTRIAL APPLICABILITY

Disclosed embodiments provide functionality for providing forecast information by part number to a supplier. Furthermore, a supplier may submit their actual current capacity for producing a part as well as a projected capacity to produce the part for a time period. In the event that a supplier cannot meet projected capacity requirement, the supplier may specify a plan outlining how the supplier intends to accomplish a planned capacity increase. The plan may also specify the means by which the supplier plans to accomplish the planned capacity increase (e.g., hiring more workers, acquiring more equipment, or increasing factory floor space). After reviewing an initial plan submitted by a supplier, the customer may require additional information specifying how the supplier plans to meet projected capacities for the time period.

Accordingly, disclosed embodiments may provide information to a customer that enables the customer to ensure that suppliers can meet demand. As a result, the customer can avoid ordering parts from other suppliers at the last minute at increased costs. The customer may further avoid obtaining parts on an expedited basis from other suppliers. Additionally, disclosed embodiments enable the customer to arrange alternative and/or additional suppliers to prevent situations in which the customer cannot deliver products to its customers due to part shortfalls.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for evaluating a capacity of a supplier to meet a capacity requirement for a part for a time period, the method comprising:
transmitting, to the supplier, a forecast indicating the capacity requirement;
receiving an actual capacity of the supplier to produce the part for the time period;
determining whether the actual capacity of the supplier meets the capacity requirement; and
when the actual capacity of the supplier does not meet the capacity requirement, receiving, from the supplier, a plan specifying how the supplier plans to meet the capacity requirement.

2. The method of claim 1, wherein the time period is divided into a plurality of subdivisions and the forecast indicates the capacity requirement for each of the subdivisions.

3. The method of claim 2, wherein the actual capacity includes a quantity of the part that the supplier plans to be able to produce for each of the subdivisions.

4. The method of claim 1, wherein the plan documents an intention of the supplier to hire more workers, acquire more equipment, or increase factory floor space.

5. The method of claim 1, further comprising:
transmitting a request to the supplier for additional information to supplement the plan.

6. The method of claim 1, further comprising:
transmitting an approval of the plan to the supplier.

7. A computer-readable medium storing instructions executable by a processor for evaluating a capacity of a supplier to meet a capacity requirement for a part for a time period according to a method, the method comprising:
transmitting, to the supplier, a forecast indicating the capacity requirement;
receiving an actual capacity of the supplier to produce the part for the time period;
determining whether the actual capacity of the supplier meets the capacity requirement; and
when the actual capacity of the supplier does not meet the capacity requirement, receiving, from the supplier, a plan specifying how the supplier plans to meet the capacity requirement.

8. The computer-readable medium of claim 7, wherein the time period is divided into a plurality of subdivisions and the forecast indicates the planned capacity requirement for each of the subdivisions.

9. The computer-readable medium of claim 8, wherein the future capacity includes a quantity of the part that the supplier plans to be able to produce for each of the subdivisions.

10. The computer-readable medium of claim 7, wherein the plan documents an intention of the supplier to hire more workers, acquire more equipment, or increase factory floor space.

11. The computer-readable medium of claim 7, the method further comprising:
transmitting a request to the supplier for additional information to supplement the plan.

12. The computer-readable medium of claim 7, the method further comprising:
transmitting an approval of the plan to the supplier.

13. A system for evaluating a capacity of a supplier to meet capacity requirements for each subdivision of a time period, the system comprising:
a server, the server comprising:
a database that stores a forecast indicating the capacity requirements for each of the subdivisions, wherein the server is operable to:
receive actual capacities of the supplier to produce a part for each of the subdivisions;
determine whether the actual capacities of the supplier for each of the subdivisions meets a corresponding one or more of the capacity requirements for each of the subdivisions; and
when one or more of the actual capacities of the supplier does not meet the corresponding one or more of the capacity requirements, receiving, from the supplier, a plan specifying how the supplier plans to meet the corresponding one or more of the capacity requirements.

14. The system of claim 13, wherein each of the actual capacities include a quantity of the part that the supplier plans to be able to produce for each of the subdivisions.

15. The system of claim 13, wherein the plan documents an intention of the supplier to hire more workers, acquire more equipment, or increase factory floor space.

16. The system of claim 13, further comprising:
transmitting a request to the supplier for additional information to supplement the plan.

17. The system of claim 13, further comprising:
transmitting an approval of the plan to the supplier.

18. A method for evaluating a capacity of a supplier to meet capacity requirements for a time period having a plurality of subdivisions, the method comprising:
transmitting, to the supplier, a forecast indicating the capacity requirements for each of the subdivisions;
receiving actual capacities of the supplier to produce an item for each of the subdivisions; and
determining whether one or more of the actual capacities of the supplier meets a corresponding one or more of the capacity requirements.

19. The method of claim 18, wherein when one or more of the actual capacities of the supplier does not meet the corresponding one or more of the capacity requirements, receiving, from the supplier, a plan specifying how the supplier plans to meet the corresponding one or more of the capacity requirements.

20. The method of claim 18, wherein the actual capacities each include a quantity of the item that the supplier plans to be able to produce for each of the subdivisions.
